(19) United States
(12) Patent Application Publication
(10) Pub. No.: US 2023/0283448 A1
(43) Pub. Date: Sep. 7, 2023

(54) SYNCHRONOUS COMMUNICATION USING LOW-PRECISION CLOCKS

(71) Applicant: Lumentum Operations LLC, San Jose, CA (US)

(72) Inventors: Hock Gin LIM, San Jose, CA (US); Chiachen CHANG, Saratoga, CA (US)

(21) Appl. No.: 18/178,115

(22) Filed: Mar. 3, 2023

Related U.S. Application Data
(60) Provisional application No. 63/268,941, filed on Mar. 7, 2022.

(51) Int. Cl. H04L 7/00; H04B 10/60

(52) U.S. Cl. CPC H04L 7/0075; H04B 10/60; H04L 7/0079

(57) ABSTRACT

In some implementations, an optical receiver may receive, from an optical transmitter, a signal that is based on a clock of the optical transmitter. The optical receiver may generate a sampling clock signal that is swept over a range of sampling rates. The optical receiver may perform, using the sampling clock signal at a sampling rate of the range of sampling rates, oversampling of the signal to detect transition edges of the signal. The optical receiver may determine that the detected transition edges are indicative of a correspondence between the sampling rate and a data rate of the signal. The optical receiver may terminate sweeping of the sampling clock signal over the range of sampling rates based on the correspondence between the sampling rate and the data rate. The optical receiver may adjust the sampling clock signal to align the sampling clock signal with transition edges of the signal.

### CROSS-REFERENCE TO RELATED APPLICATION

This patent application claims priority to U.S. Provisional Patent Application No. 63/268,941, filed on Mar. 7, 2022, and entitled “LOW-SPEED SYNCHRONOUS COMMUNICATION.” The disclosure of the prior application is considered part of and is incorporated by reference into this patent application.

### TECHNICAL FIELD

The present disclosure relates generally to optical transceivers and to synchronous communication using low-precision clocks in electronics for optical networks.

### BACKGROUND

An optical module (e.g., an optical transceiver) capable of achieving high-speed data communication may be used in a data center, a node of an optical network, or the like. An optical transceiver may include, as main components, a light emitting function portion (transmitter optical subassembly, TOSA) that converts electrical signals into optical signals and a light receiving function portion (receiver optical subassembly, ROSA) that, in turn, converts optical signals into electrical signals for high-speed data communication in an optical network, such as a fiber optic network.

### SUMMARY

In some implementations, a controller for an optical receiver includes a clock, one or more processors, and a memory storing instructions that, when executed by the one or more processors, cause the controller to perform, using a sampling clock signal at a sampling rate, oversampling of a signal that is received to detect transition edges of the signal, where the signal is a secondary low-speed signal that is modulated on a primary high-speed signal, and where the sampling rate is in a range of sampling rates over which the sampling clock signal is swept. The instructions, when executed by the one or more processors, may cause the controller to determine that the detected transition edges are indicative of a correspondence between the sampling rate and a data rate of the signal. The instructions, when executed by the one or more processors, may cause the controller to adjust the sampling clock signal to align the sampling clock signal with transition edges of the signal.

In some implementations, an optical receiver includes a controller with a first clock. The controller may be configured to receive a signal from a remote optical transmitter, where the signal is based on a second clock of the remote optical transmitter, and where the signal is a secondary low-speed signal that is modulated on a primary high-speed signal. The controller may be configured to generate a sampling clock signal that is to be swept over a range of sampling rates that are based on the first clock. The controller may be configured to perform, using the sampling clock signal at a sampling rate of the range of sampling rates, oversampling of the signal to detect transition edges of the signal. The controller may be configured to determine that the detected transition edges are indicative of a correspondence between the sampling rate and a data rate of the signal, where sweeping of the sampling clock signal over the range of sampling rates is to be terminated based on the correspondence between the sampling rate and the data rate. The controller may be configured to adjust the sampling clock signal to align the sampling clock signal with transition edges of the signal by causing a clock slip of the sampling clock signal, by causing a clock insert of the sampling clock signal, or by adjusting a period of the sampling clock signal.

In some implementations, a method of low-speed synchronous communication over a primary high-speed data signal includes receiving, by an optical receiver and from a remote optical transmitter, a signal that is based on a clock of the optical transmitter, where the signal is a low-speed signal that is modulated on the primary high-speed signal. The method may include generating, by the optical receiver, a sampling clock signal that is swept over a range of sampling rates. The method may include performing, using the sampling clock signal at a sampling rate of the range of sampling rates, oversampling of the signal to detect transition edges of the signal. The method may include determining that the detected transition edges are indicative of a correspondence between the sampling rate and a data rate of the signal. The method may include terminating sweeping of the sampling clock signal over the range of sampling rates based on the correspondence between the sampling rate and the data rate. The method may include adjusting the sampling clock signal to align the sampling clock signal with transition edges of the signal.

### BRIEF DESCRIPTION OF THE DRAWINGS

FIGS. 1A-1D are diagrams of an example associated with synchronous communication using low-precision clocks.

FIG. 2 is a diagram of an example environment in which systems and/or methods described herein may be implemented.

FIG. 3 is a diagram of example components of one or more devices of FIG. 2.

FIG. 4 is a flowchart of an example process relating to synchronous communication using low-precision clocks.

### DETAILED DESCRIPTION

The following detailed description of example implementations refers to the accompanying drawings. The same reference numbers in different drawings may identify the same or similar elements.

Network nodes of an optical network may exchange information to maintain a performance of the network at a high level independently of the network nodes' normal operation of transmitting high-speed data through the network. In particular, a receiving network node (e.g., a head end (HE) node) may receive (e.g., using an optical transceiver) messages that include diagnostic information from a transmitting network node (e.g., a tail end (TE) node). Such messages may be low-speed data and may be generated by applying a low-speed data signal over a primary high-speed data signal (e.g., the low-speed data signal may be in-band with, and modulated on, the primary high-speed network data signal, but operating at a significantly lower data rate). In some examples, the receiving network node may receive the messages in an asynchronous manner on a supervisory channel on a common public radio interface (CPRI) link. For example, the receiving network node may employ particular hardware (which may be referred to as a “management central processing unit (CPU)”) for supervisory channel processing, which increases a size and a complexity of the receiving network node.

In some other examples, the receiving network node may receive the messages in a synchronous manner. This may require an optical transceiver of the receiving network node to need a high-precision clock (e.g., associated with a variation of up to 0.01% or 100 parts per million (ppm)), which has an additional cost and/or footprint relative to a pre-existing low-precision clock (e.g., associated with a variation from 0.05% to 10% or 500 ppm to 100,000 ppm). A high-precision clock may have a precision that is 1,000 times greater than a precision of a low-precision clock. However, an optical transceiver is generally associated with a small form factor (e.g., SFP, XFP, SFP+, SFP28, QSFP28, SFP-DD, SFP56, OSFP 800G, among many other examples) having limited available space for additional hardware (e.g., for a high-precision clock chip), such that adding a high-precision clock is impractical. While low-precision clocks are already present in existing optical transceivers, they may time drift (e.g., due to low precision), causing the timing used for transmission and reception to vary. Thus, the use of low-precision clocks for synchronous communication, even of low-speed signals, can result in high error rates and poor performance. In some cases, an optical transceiver may include dedicated clock recovery hardware to recover a clock signal and/or data that has been lost due to time variations. However, the clock recovery hardware may be unable to recover large and/or frequent clock variations, increases the complexity and power consumption of the optical transceiver, and would also take up additional space within the optical transceiver.

In some implementations described herein, an optical receiver can use a low precision clock to receive synchronous communications with low error rates even if the received signal was sent using a low precision clock. The optical receiver may compensate for clock and signal variations by using firmware within the optical receiver and without needing to add dedicated clock recovery hardware or a high precision clock. Such an optical receiver may then use this low precision clock compensation to maintain synchronous, low-speed data communications over a primary high-speed data signal otherwise being received by the optical receiver. Accordingly, implementations described herein enable the use of low-precision clocks for synchronous communication between an optical receiver and a remote optical transmitter (e.g., in a worst case where both the optical receiver and the transmitting system are communicating using low-precision clocks). A low-precision clock may be in a microcontroller unit (MCU) of an optical transceiver (e.g., the MCUs of existing optical transceivers may employ low-precision clocks). For example, the MCU may include an integrated oscillator used for generating a clock signal for the MCU. MCUs have low precision clocks because MCU clocks may vary by a large percentage from a target frequency (e.g., due to the device being exposed to different temperatures, aging, etc.). Accordingly, such an optical transceiver may be used for synchronous communication in accordance with implementations described herein, and without adding a high-precision clock and associated hardware (e.g., a high-precision clock chip) and/or without additional clock recovery hardware.

In some implementations, low-speed synchronous communication may be established by searching for a clock rate of a received signal, locking on a particular clock rate to allow communication to commence, and then maintaining a lock with the received signal by adjusting the locked rate. If the lock is lost, or too many corrections are required to maintain the lock, communication may stop and searching for a clock rate of the received signal may restart. Below, this general description and alternatives are elaborated.

In some implementations, a low-speed synchronous signal may be generated by an optical transmitter, sent over an optical network, and then received by an optical receiver. The signal may have a low precision data rate because it is transmitted using a low precision clock in the optical transmitter. The signal may further be received with poor precision because the optical receiver also has a low precision clock. The combination of two low precision clocks may create significant clock variations. Nevertheless, a control process implemented in the optical receiver may maintain the signal between the optical transmitter and the optical receiver as a low error rate synchronous communication as follows. The optical receiver may oversample the signal many times while sweeping a range of clock rates to detect a particular clock rate that corresponds to the rate of the signal currently being received. When this correspondence is identified, the optical receiver may lock this particular clock rate and receive synchronous data from the signal. While receiving synchronous data from the signal, the optical receiver may continue oversampling the signal at the particular clock rate to anticipate a clock variation error, and in response to such anticipated error, the optical receiver may correct the clock variation (e.g., insert an additional clock edge, or skip a clock edge, adjust phase, or adjust a sampling timer) and, ideally, avoid the error and consequent data loss. If a quantity of corrections is too great over a period of time, or if synchronization is otherwise lost, then the optical receiver may stop receiving data at the particular clock rate and return to identifying a corresponding clock rate. While receiving synchronous data from the signal (and despite having already locked the particular clock rate), the optical receiver may continue to oversample the signal. By continuously maintaining oversampled data for the range of clock rates, the optical receiver may promptly identify a new corresponding clock rate when synchronization is lost. Accordingly, receiving synchronous data from the signal at a new clock rate can resume quickly after locking has been lost and data loss can be further reduced. In some implementations, when synchronization is lost, the clock rate may be swept at a smaller range associated with a previous locked clock rate, or rates, to reduce the clock searching time. The control algorithm implementing this process can be provided in a firmware, a field-programmable gate array (FPGA), an application-specific integrated circuit (ASIC), or as instructions in a memory of the optical receiver. Thereby, the optical receiver can enable low error rate synchronous communication from the signal using the optical receiver's low precision clock without the addition of a high precision optical clock and without the addition of clock or data recovery hardware.

An optical receiver implementing this control process may also include hardware to separate a low-speed signal from, and a primary high-speed data signal from, an incoming optical signal. Conversely, an optical transmitter implementing this synchronous communication may also include hardware to introduce a low-speed signal onto a primary high-speed data signal.

In some implementations, an optical receiver (e.g., of an optical transceiver) may receive a signal from a remote optical transmitter (e.g., of another optical transceiver or from some other network or diagnostic hardware). The signal may be a low-speed signal having a synchronous data rate on the order of kilobits per second (kbps). The signal may have a low precision data rate because it is generated based on a low-precision clock. The signal may contain diagnostic information such as, but not limited to, identification, status, performance, security, network, connectivity, power, configuration, and other diagnostic information. The signal may be in-band with, and modulated on, a primary high-speed signal. The high-speed data signal may be a signal for carrying network or customer data through the optical network. The high-speed data signal may have a data rate on the order of gigabits per second (Gbps), for example, 1 Gbps to 100 Gbps (e.g., 10 Gbps or 25 Gbps), and other rates.

The optical receiver may include a controller that performs sweeping and oversampling of the signal, using a sampling clock signal (e.g., that is generated using a low-precision clock of the controller), to detect transition edges of the signal (e.g., the low-speed signal described above). Based on detecting the transition edges, the controller may determine whether the detected transition edges are indicative of a correspondence (e.g., identifying a strong correlation) between a sampling rate of the sampling clock signal and a data rate of the received signal. If there is the correspondence, the controller may continue to sample (e.g., lock) the signal using the sampling clock signal at the sampling rate. If, after continuing at the sampling rate, transition edges of the received signal are occurring or anticipated to be occurring, early or late relative to the sampling clock signal, the controller may adjust the sampling clock signal to improve alignment of the sampling clock signal with transition edges of the received signal. If there are too many early or late edges, the controller may release the correspondence (e.g. unlock the clock) and use the frequency sweeping and oversampling to attempt to regain the correspondence. By maintaining correspondence of the sampling clock signal and the signal, synchronous communication is possible. By adjusting the sampling clock (e.g., as transition edges are detected to be early or late), the synchronous communication may have a decreased error rate.

By maintaining clock alignment in this way, the optical transmitter and the optical receiver may engage in synchronous communication without the use of high-precision clocks while maintaining high messaging performance and low error rates. Moreover, using existing low-precision clocks in the optical transmitter and the optical receiver avoids adding additional high precision clocks, thereby reducing the complexity of the optical transmitter and the optical receiver and facilitating a smaller footprint device.

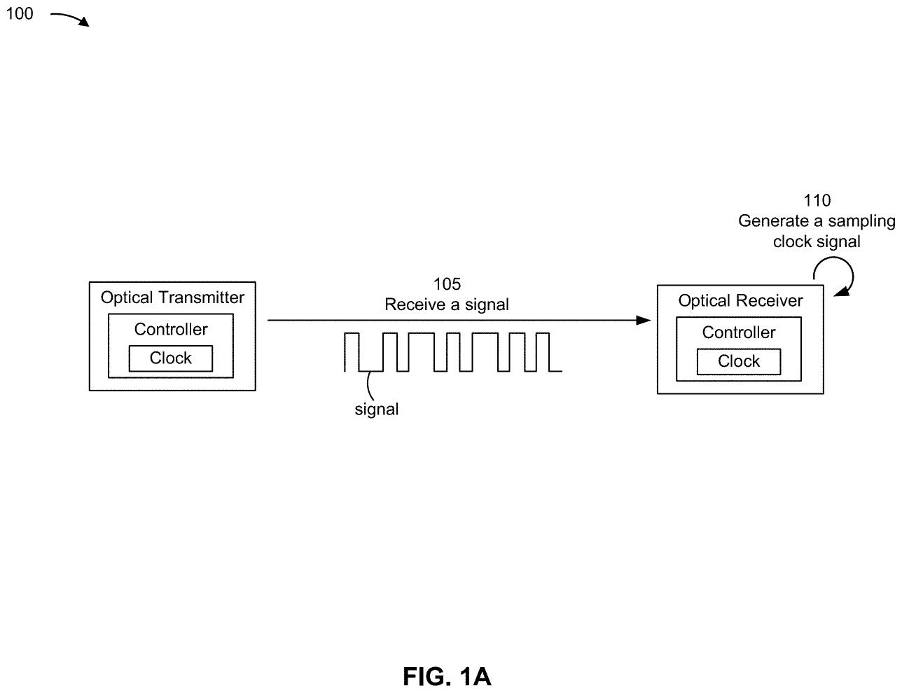

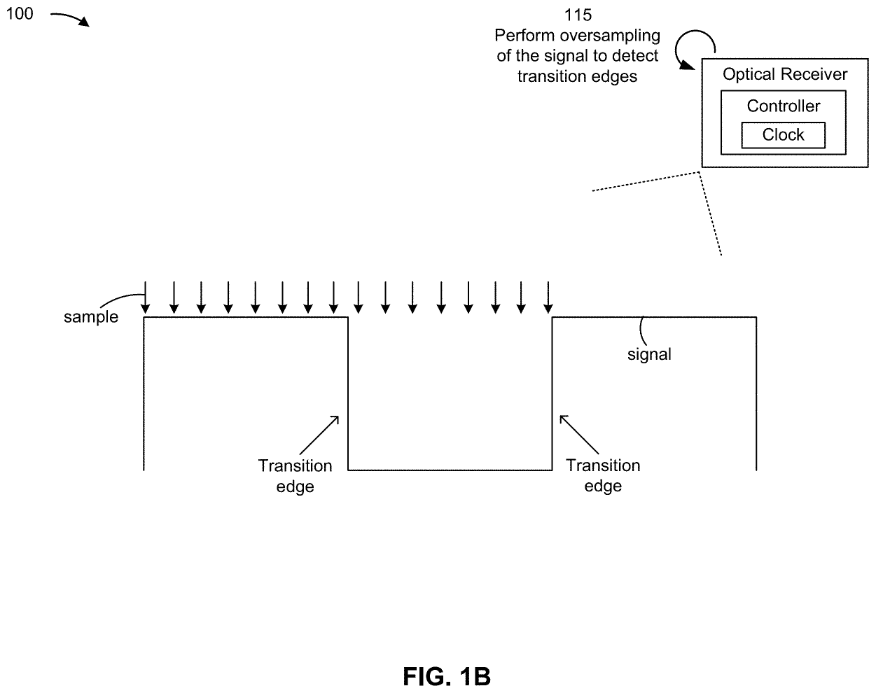

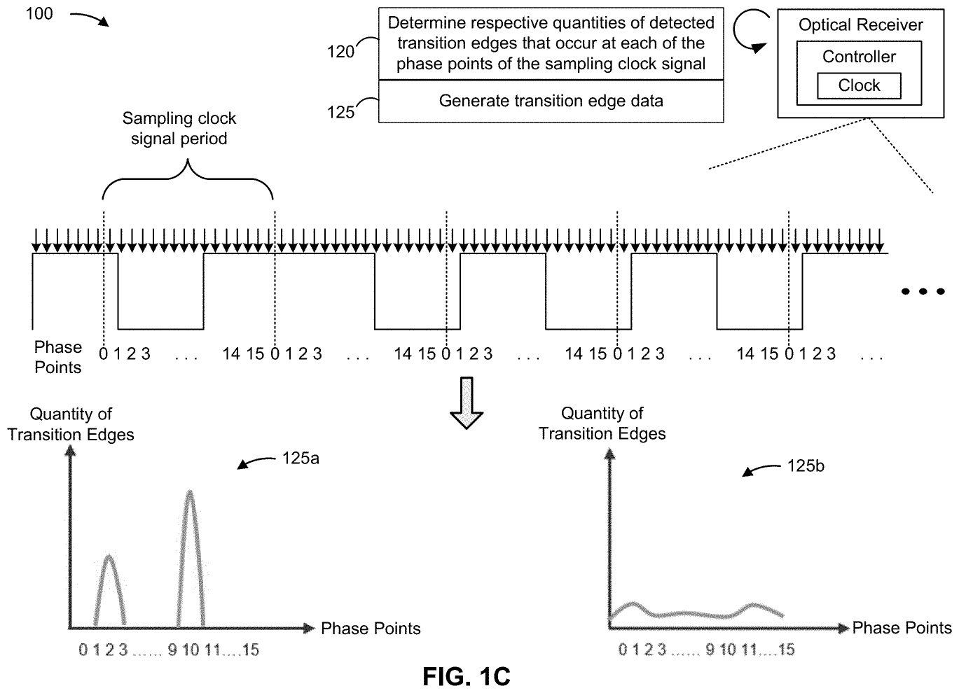

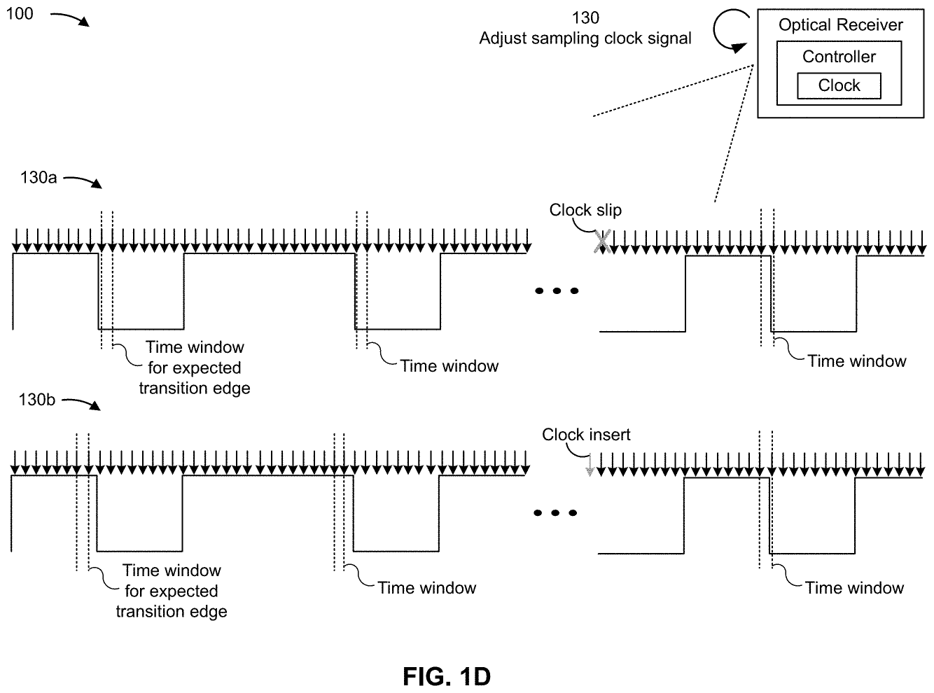

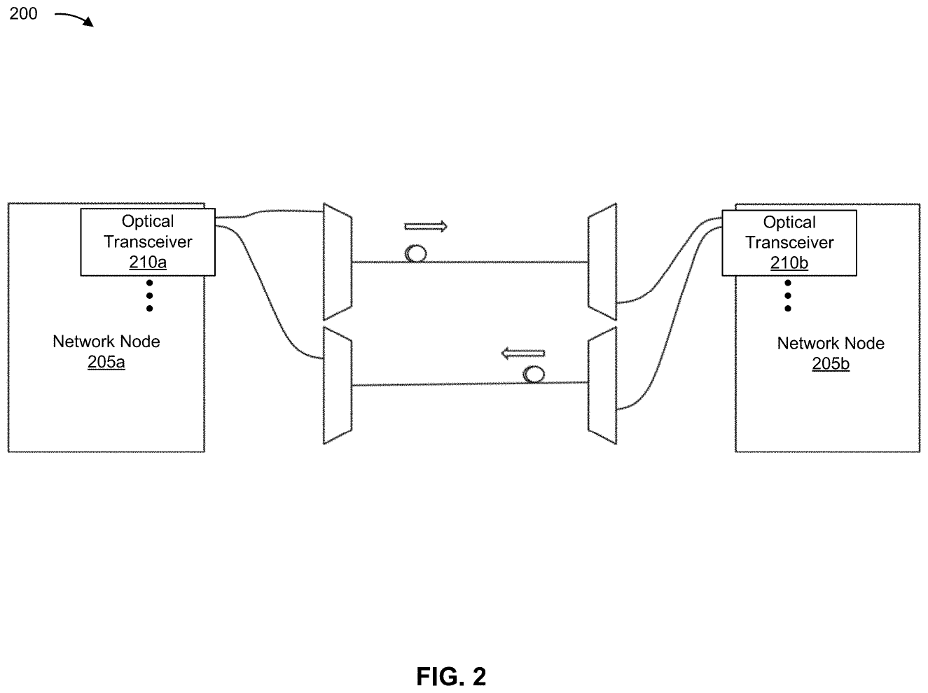

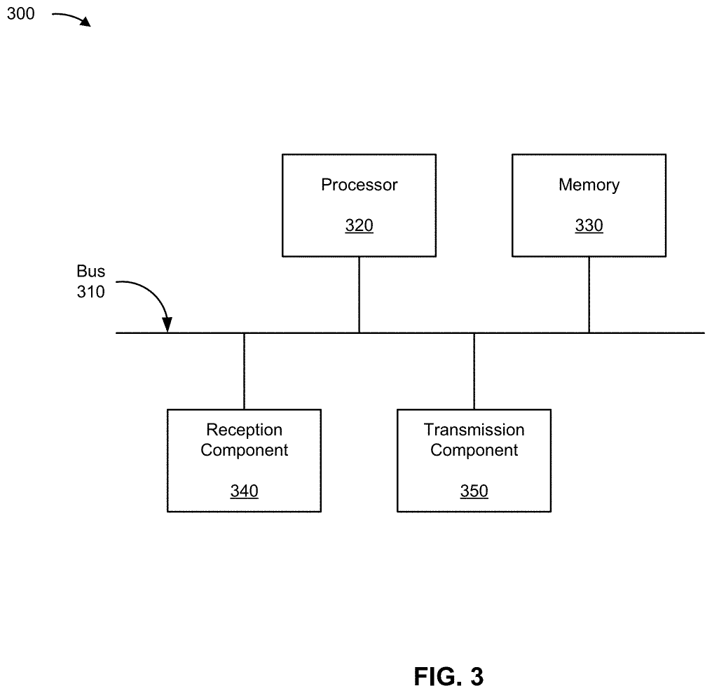

FIGS. 1A-1D are diagrams of an example 100 associated with synchronous communication using low-precision clocks. As shown in FIGS. 1A-1D, example 100 includes an optical transmitter and an optical receiver. The optical transmitter may be remotely located from the optical receiver (e.g., the optical transmitter and the optical receiver are not co-located) in an optical communications network. These devices are described in more detail in connection with FIGS. 2 and 3.

As shown, the optical transmitter may include a controller (e.g., an MCU), and the controller may include a clock (e.g., the clock is an internal clock of the controller), such as an integrated oscillator of the controller. Similarly, the optical receiver may include a controller (e.g., an MCU), and the controller may include a clock (e.g., the clock is an internal clock of the controller), such as an integrated oscillator of the controller. The clocks of the optical transmitter and/or the optical receiver are low-precision clocks. For example, the clocks may each have a variation in a range from 0.05% to 10%, 0.1% to 5%, 0.5% to 5%, 1% to 5%, 2% to 5%, 3% to 5%, or 4% to 5%. In some implementations, the optical transmitter may be included in (e.g., a component of) a first optical transceiver, and the optical receiver may be included in (e.g., a component of) a second optical transceiver in an optical communications network.

In some implementations, the optical transmitter (or the optical transceiver that includes the optical transmitter) may be, or may be included in, a network node, as described in more detail in connection with FIG. 2. In some implementations, the optical receiver (or the optical transceiver that includes the optical receiver) may be, or may be included in, a network node, as described in more detail in connection with FIG. 2.

In some implementations, the optical transmitter and the optical receiver may be part of a synchronous communication system that is independent of primary high-speed data communications by the optical transmitter and/or the optical receiver, but using the same optical communication network. That is, the optical transmitter and the optical receiver may synchronously communicate with each other. The synchronous communication may be associated with low-speed data communication (e.g., at 10 kilobits per second (kbps), 5 kbps, or 2.5 kbps, among other examples). Here, low-speed data may be transmitted using a low-speed data signal modulated over a primary high-speed data signal. The low-speed data may include messages with network information, diagnostic information, and/or other information.

As shown in FIG. 1A, and by reference number 105, the controller of the optical receiver may receive a signal (e.g., a data signal) transmitted by the optical transmitter. For example, a receiver optical subassembly of the optical receiver may receive the signal as an optical signal from the optical transmitter, and the receiver optical subassembly may convert the optical signal into an electrical signal that can be processed by the controller. The signal may have a data rate on the order of kilobits per second (kbps) that is based on the clock (e.g., a low-precision clock) of the optical transmitter (e.g., the optical transmitter may have generated the signal using the clock). In contrast, a high-speed data signal, onto which the signal may be modulated, may have a data rate on the order of gigabits per second (Gbps), for example, 1 Gbps to 100 Gbps, and other rates.

In some implementations, the signal may be a secondary low-speed signal that is modulated on a primary high-speed signal. For example, the optical receiver may receive an optical signal that includes the secondary low-speed signal modulated on the primary high-speed signal, and the optical receiver may be configured to extract the signal (e.g., the secondary low-speed signal) from the optical signal. In some implementations, a nominal synchronous data rate of the low-speed signal may be 10 kbps or less, 5 kbps or less, or 2.5 kbps or less, among other examples. As described herein, the signal may be associated with synchronous communication between the optical transmitter and the optical receiver.

In some implementations, the signal may be encoded by Manchester encoding. A Manchester encoded signal may have frequent transition edges. A “transition edge” (which can also be referred to as a “data edge”) may refer to a transition of a signal from a low level to a high level or from a high level to a low level. Moreover, transition edges of a Manchester encoded signal may be aligned with edges of a clock signal used to generate the Manchester encoded signal. In some implementations, the signal may be encoded by another type of encoding that produces a signal having frequent transition edges and/or a signal for which transition edges are aligned with edges of a clock signal used to generate the signal.

As shown by reference number 110, the controller of the optical receiver may generate a sampling clock signal (e.g., that is generated using the clock of the controller). The sampling clock signal may have a controllable sampling rate. In particular, the sampling clock signal may be swept over a range of sampling rates to identify a sampling rate that corresponds to a data rate of the signal.

As shown in FIG. 1B, and by reference number 115, the controller of the optical receiver may perform oversampling of the signal. For example, the oversampling may be a 16× oversampling compared to an expected rate of the signal. The controller may perform the oversampling continuously (e.g., constantly, without stopping), for example, using a ping-pong direct memory access (DMA) technique. The controller may perform the oversampling using the sampling clock signal. For example, the controller may perform the oversampling while sweeping the sampling clock signal over the range of sampling rates, as described herein. The controller may perform the oversampling to detect transition edges of the signal. That is, the frequent sampling used by the oversampling enables detection of transition edges of the signal that otherwise could not be detected by less-frequent sampling of the signal.

The controller may be configured to perform a clock locking procedure. For example, the controller may be configured in firmware to perform the clock locking procedure. The firmware may include a set of instructions stored in a memory of the controller and executable by one or more processors of the controller.

The clock locking procedure can be used to monitor and identify a data rate of the signal, to enable the optical receiver to receive the signal with a reduced error rate, despite the optical receiver and the optical transmitter using low-precision clocks. The clock locking procedure may include clock searching operations and clock locking operations. The clock searching operations may be used to lock the sampling clock signal with a data rate of the signal, and the clock locking operations may be used to align the sampling clock signal with transition edges of the signal.

Using the clock searching operations, the controller of the optical receiver may determine whether detected transition edges are indicative of a correspondence between a sampling rate of the sampling clock signal and a data rate of the signal. For the clock searching operations, the controller may sweep the sampling clock signal in steps (referred to herein as “sweeping steps”) over a range of sampling rates. For example, the sampling clock signal may be swept in steps from −10% to +10% or −5% to +5%, among other examples, of a nominal data rate anticipated or expected for the received signal (e.g., 5 kilobits per second). In some implementations, a step used for sweeping the sampling clock signal may be 25 nanoseconds. As an example, if the sampling clock signal is swept in 25 nanosecond steps from −5% to +5% of the nominal data rate, and if the nominal data rate is associated with clock pulses that occur every 100 microseconds, then a first sweeping step may use a sampling rate associated with clock pulses that occur every 95 microseconds, a second sweeping step may use a sampling rate associated with clock pulses that occur every 95.025 microseconds, and so forth.

FIG. 1C shows an example of the clock searching operations for one sweeping step. The sweeping step may include multiple bits of the signal. For example, the sweeping step may include a 32 bit period of the signal. In general, a maximum quantity of bits used for one sweeping step (e.g., in order to obtain usable data for the operations described below) may be based on a period of a sample bit (e.g., 12.5 microseconds, for example, when a step size of one sweeping step is 25 nanoseconds), a step size used for sweeping the sampling clock signal (e.g., 25 nanoseconds), and a quantity of samples per bit (e.g., 16 samples at a 5000 baud rate). For example, the maximum quantity of bits used for one sweeping step may be half the period of a sample bit (e.g., 6.25 microseconds, representing a maximum phase shift) divided by the product of half the step size of a sweeping step (e.g., 12.5 nanoseconds) and the quantity of samples per bit (e.g., 16 samples).

As shown, in a period of the sampling clock signal, a phase of the sampling clock signal may be characterized at a plurality of phase points (e.g., that are evenly distributed across the period). The quantity of phase points in a period of the sampling clock signal may correspond to the quantity of samples in the period of the sampling clock signal. For example, the phase of the sampling clock signal may be characterized at 16 phase points (which may be designated as phase points 0 to 15, as shown) in a period of the sampling clock signal (e.g., when the oversampling is 16× oversampling). The sweeping step may include multiple periods of the sampling clock signal (e.g., the sweeping step may include multiple cycles through the plurality of phase points). Moreover, at the start of the sweeping step, the controller of the optical receiver may initialize (e.g., set to zero) a plurality of counters. The quantity of counters may correspond to the quantity of phase points in a period of the sampling clock signal, and each counter may be associated with a respective phase point. For example, a first counter may be associated with phase point 0, a second counter may be associated with phase point 1, a third counter may be associated with phase point 2, and so forth.

In the sweeping step, the controller of the optical receiver may determine whether each sample of the signal is associated with a transition edge of the signal (e.g., based on oversampling the signal, as described herein). For example, the controller may determine that a sample is associated with a transition edge if, at the sample, the signal is changing from a high level to a low level or from a low level to a high level. If a sample is determined to be associated with a transition edge, then the controller may increment the counter for the phase point associated with the sample. For example, if a sample obtained at phase point 10 of the sampling clock signal is determined to be associated with a transition edge, then the counter for phase point 10 may be incremented. Thus, the counters track the quantity of transition edges that are detected at each phase point in a sweeping step. Accordingly, as shown by reference number 120, to determine whether detected transition edges are indicative of a correspondence between the clock rate of the sampling clock signal, used for the sweeping step, and the data rate of the signal, the controller of the optical receiver may determine respective quantities of the detected transition edges of the signal that occur at each of the plurality of phase points of the sampling clock signal.

Furthermore, to determine whether detected transition edges are indicative of a correspondence between the sampling rate of the sampling clock signal, used for the sweeping step, and the data rate of the signal, as shown by reference number 125, the controller of the optical receiver may generate transition edge data that indicates whether the sampling rate of the sampling clock signal is closely aligned with the data rate of the data signal. For example, the controller may generate transition edge data that indicates respective quantities of the detected transition edges that occur at each of the phase points (e.g., the transition edge data may be generated based on the values of the counters). Continuing with the example, the controller may determine whether the transition edge data indicates at least one distinct peak (e.g., a peak at a phase point may be determined if a quantity of transition edges associated with the phase point is a threshold amount higher, a percentage amount higher, or the like, than a quantity of transition edges associated with any other phase point). In particular, if the sampling rate of the sampling clock signal is closely aligned with the data rate of the data signal, then the transition edge data may indicate at least one distinct peak. For example, as shown by histogram 125a, which provides an example illustration of the transition edge data, the transition edge data may indicate two distinct peaks (e.g., when Manchester encoding is used for the signal). Conversely, as shown by histogram 125b, which provides another example illustration of the transition edge data, if the sampling rate of the sampling clock signal is not closely aligned with the data rate of the signal, then the transition edge data may not indicate any distinct peaks.

Accordingly, the controller of the optical receiver may determine that detected transition edges are indicative of a correspondence between the sampling rate of the sampling clock signal, used for the sweeping step, and the data rate of the signal based on the transition edge data indicating at least one distinct peak (e.g., two distinct peaks). In other words, the controller may determine that the sampling rate of the sampling clock signal, used for the sweeping step, is closely aligned with the data rate of the signal (e.g., expected transitions of the signal correspond to a phase of the sampling clock signal). Here, the controller may declare clock locking and proceed with using (e.g., the controller may continue to use) the sampling rate of the sweeping step for the sampling clock signal. Thus, the controller may terminate sweeping of the sampling clock signal based on the correspondence between the sampling rate of the sampling clock signal and the data rate of the signal. Conversely, if the controller determines (e.g., based on the transition edge data) that there is no correspondence between the sampling rate of the sampling clock signal, used for the sweeping step, and the data rate of the signal (e.g., the sampling rate and the data rate are not closely aligned), then the controller may proceed to another sweeping step for sweeping the sampling clock signal. Accordingly, the controller may perform one or more sweeping steps for the clock searching operations until correspondence between the sampling rate of the sampling clock signal and the data rate of the signal is determined.

Once the clock searching operations are complete and the sampling clock rate is locked to the data rate of the signal, synchronous data transmission of the signal (e.g., the low-speed data signal) can commence. However, because the clocks involved are low precision, there are many ways that the locking between the selected sampling clock rate and the signal's data rate could be lost. Accordingly, after completing the clock searching operations, the controller may perform clock locking operations which may include adjusting the sampling clock rate to maintain locking and/or alignment.

As shown in FIG. 1D, and by reference number 130, after locking the sampling clock signal, the controller of the optical receiver may adjust the sampling clock signal to align the sampling clock signal with transition edges of the signal (e.g., to correct for the data rate of the signal slipping from the locked sampling clock signal). That is, upon declaring clock locking, the controller may begin performing the clock locking operations. The clock locking operations may include multiple clock aligning loops to align the sampling clock signal with transition edges of the data signal. For example, the clock locking operations may include a slip-or-insert operation (which is performed in a “fast” loop) and a period adjustment operation (which is performed in a “slow” loop).

For the slip-or-insert operation, the controller of the optical receiver may determine whether transition edges of the data signal are to occur early or late with respect to the sampling clock signal. For example, the sampling clock signal, at the locked sampling rate, may define time windows in which transition edges of the data signal are expected, and the controller may determine whether transition edges of the data signal are to occur early or late with respect to the time windows (e.g., due to time drift). As shown by reference number 130a, if the transition edges are determined to occur early, then the controller, to adjust the sampling clock signal, may cause a clock slip of the sampling clock signal, to thereby align the sampling clock signal with transition edges of the data signal. To cause the clock slip, the controller may cause a forward (in time) shift of a phase (e.g., a digital phase shift) of the sampling clock signal. As shown by reference number 130b, if the transition edges are determined to occur late, then the controller, to adjust the sampling clock signal, may cause a clock insert of the sampling clock signal, to thereby align the sampling clock signal with transition edges of the data signal. To cause the clock insert, the controller may cause a backward (in time) shift of a phase (e.g., a digital phase shift) of the sampling clock signal. In this way, the slip-or-insert operation may provide immediate alignment of the sampling clock signal with transition edges of the data signal.

For the period adjustment operation, the controller of the optical receiver may determine whether clock slips or clock inserts for the slip-or-insert operation are occurring too frequently. For example, the controller may monitor a quantity of clock slips or clock inserts that have occurred within a particular time period (e.g., 64 bits of the signal at a 5 kbps data rate when the oversampling is 16× oversampling) to determine whether the quantity satisfies a threshold (e.g., the threshold may be four clock slips or four clock inserts). If the quantity satisfies the threshold, the controller, to adjust the sampling clock signal, may cause adjustment to a period of the sampling clock signal. For example, the controller may cause an increase or a decrease to a length of a period of the sampling clock signal (e.g., by increasing or decreasing the period of the sampling clock signal by the step size used for sweeping, as described above). In this way, the period adjustment operation may correct a misalignment of the sampling clock signal and the data rate of the signal that may occur due to changes in temperature or clock aging.

The oversampling performed by the controller of the optical receiver may also be used to obtain data from the signal. For example, based on the alignment of the sampling clock signal with transition edges of the data signal, the controller may decode the signal (e.g., from samples obtained by oversampling the data signal) and obtain data from the signal. In some examples, the controller may determine that the data has errors or is otherwise unusable. Here, the controller may declare that the clock locking is lost, and the controller may return to performing the clock searching operations, as described herein. In this way, the optical transmitter and the optical receiver may synchronously communicate using low-precision clocks.

As indicated above, FIGS. 1A-1D are provided as an example. Other examples may differ from what is described with regard to FIGS. 1A-1D.

FIG. 2 is a diagram of an example environment 200 in which systems and/or methods described herein may be implemented. As shown in FIG. 2, environment 200 may include a network node 205a and a network node 205b.

The network node 205a includes one or more devices capable of receiving, generating, storing, processing, providing, and/or routing information associated with communications with the network node 205b, as described elsewhere herein. The network node 205a may include a TE node. For example, the network node 205a may include a baseband unit of a wireless network. In some implementations, the network node 205a may include a distributed unit of a hub site of a wireless network. As shown, the network node 205a may include one or more optical transceivers 210a. An optical transceiver 210a may include the optical transmitter described herein.

The network node 205b includes one or more devices capable of receiving, generating, storing, processing, providing, and/or routing information associated with communications with the network node 205a, as described elsewhere herein. The network node 205b may include an HE node. For example, the network node 205b may include a radio head of a wireless network. In some implementations, the network node 205b may include a radio unit of a cell site of a wireless network. As shown, the network node 205b may include one or more optical transceivers 210b. An optical transceiver 210b may include the optical receiver described herein.

The optical transceiver(s) 210a of the network node 205a and the optical transceiver(s) 210b of the network node 205b may communicate via a fiber optic network. In some implementations, the optical transceiver(s) 210a of the network node 205a and the optical transceiver(s) 210b of the network node 205b may communicate on backhaul links or fronthaul links.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

FIG. 3 is a diagram of example components of a device 300, which may correspond to the network node 205a, the network node 205b, the optical transceiver 210a, and/or the optical transceiver 210b. In some implementations, the network node 205a, the network node 205b, the optical transceiver 210a, and/or the optical transceiver 210b include one or more devices 300 and/or one or more components of device 300. As shown in FIG. 3, device 300 may include a bus 310, a processor 320, a memory 330, an input component 340, an output component 350, and a communication component 360.

Bus 310 includes one or more components that enable wired and/or wireless communication among the components of device 300. Bus 310 may couple together two or more components of FIG. 3, such as via operative coupling, communicative coupling, electronic coupling, and/or electric coupling. Processor 320 includes a central processing unit, a graphics processing unit, a microprocessor, a controller, a microcontroller, a digital signal processor, a field-programmable gate array, an application-specific integrated circuit, and/or another type of processing component (e.g., a microcontroller unit and/or a controller of an optical transceiver). Processor 320 may include a low-precision clock. Processor 320 is implemented in hardware, firmware, software, or combinations thereof. In some implementations, processor 320 includes one or more processors capable of being programmed to perform one or more operations or processes described elsewhere herein.

Memory 330 includes volatile and/or nonvolatile memory. For example, memory 330 may include random access memory (RAM), read only memory (ROM), a hard disk drive, and/or another type of memory (e.g., a flash memory, a magnetic memory, and/or an optical memory), for example, to store firmware within an optical transceiver. Memory 330 may include internal memory (e.g., RAM, ROM, or a hard disk drive) and/or removable memory (e.g., removable via a universal serial bus connection). Memory 330 may be a non-transitory computer-readable medium. Memory 330 stores information, instructions, and/or software (e.g., one or more software applications) related to the operation of device 300. In some implementations, memory 330 includes one or more memories that are coupled to one or more processors (e.g., processor 320), such as via bus 310.

Reception component 340 enables device 300 to receive signals (e.g., optical signals). For example, reception component 340 may include a reception optical subassembly that converts optical signals (e.g., received in an optical network) into electrical signals. Transmission component 350 enables device 300 to transmit signals (e.g., optical signals). For example, transmission component 350 may include a transmission optical subassembly that converts electrical signals into optical signals (e.g., for transmission in an optical network).

Device 300 may perform one or more operations or processes described herein (including, for example, processes and operations performed by a controller of an optical transceiver). For example, a non-transitory computer-readable medium (e.g., memory 330) may store a set of instructions (e.g., one or more instructions or code) for execution by processor 320. Processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry is used instead of or in combination with the instructions to perform one or more operations or processes described herein. Additionally, or alternatively, processor 320 may be configured to perform one or more operations or processes described herein. Thus, implementations described herein are not limited to any specific combination of hardware circuitry and software.

The number and arrangement of components shown in FIG. 3 are provided as an example. Device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

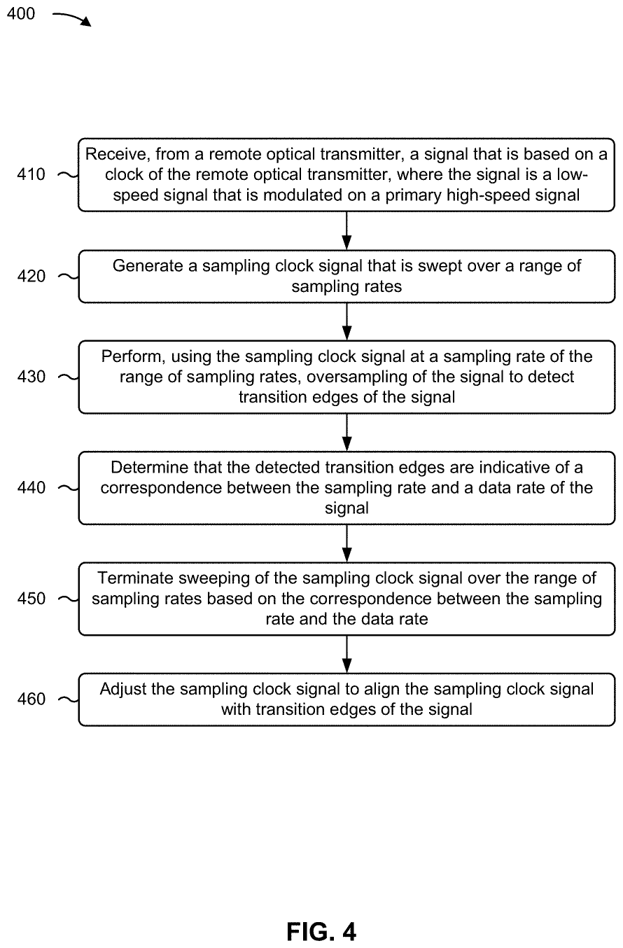

FIG. 4 is a flowchart of an example process 400 associated with synchronous communication using low-precision clocks. In some implementations, one or more process blocks of FIG. 4 are performed by an optical receiver (e.g., of optical transceiver 210b). In some implementations, one or more process blocks of FIG. 4 are performed by another device or a group of devices separate from or including the optical receiver. Additionally, or alternatively, one or more process blocks of FIG. 4 may be performed by one or more components of device 300, such as processor 320, memory 330, input component 340, output component 350, and/or communication component 360.

As shown in FIG. 4, process 400 may include receiving, from a remote optical transmitter, a signal that is based on a clock of the remote optical transmitter, where the signal is a low-speed signal that is modulated on a primary high-speed signal (block 410). For example, the optical receiver may receive, from a remote optical transmitter, a signal that is based on a clock of the optical transmitter. In some implementations, the signal is a low-speed signal that is modulated on a primary high-speed signal.

As further shown in FIG. 4, process 400 may include generating a sampling clock signal that is swept over a range of sampling rates (block 420). For example, the optical receiver may generate a sampling clock signal that is swept over a range of sampling rates, as described above.

As further shown in FIG. 4, process 400 may include performing, using the sampling clock signal at a sampling rate of the range of sampling rates, oversampling of the signal to detect transition edges of the signal (block 430). For example, the optical receiver may perform, using the sampling clock signal at a sampling rate of the range of sampling rates, oversampling of the signal to detect transition edges of the signal, as described above.

As further shown in FIG. 4, process 400 may include determining that the detected transition edges are indicative of a correspondence between the sampling rate and a data rate of the signal (block 440). For example, the optical receiver may determine that the detected transition edges are indicative of a correspondence between the sampling rate and a data rate of the signal, as described above.

As further shown in FIG. 4, process 400 may include terminating sweeping of the sampling clock signal over the range of sampling rates based on the correspondence between the sampling rate and the data rate (block 450). For example, the optical receiver may terminate sweeping of the sampling clock signal over the range of sampling rates based on the correspondence between the sampling rate and the data rate, as described above.

As further shown in FIG. 4, process 400 may include adjusting the sampling clock signal to align the sampling clock signal with transition edges of the signal (block 460). For example, the optical receiver may adjust the sampling clock signal to align the sampling clock signal with transition edges of the signal, as described above.

Process 400 may include additional implementations, such as any single implementation or any combination of implementations described below and/or in connection with one or more other processes described elsewhere herein.

In a first implementation, adjusting the sampling clock signal to align the sampling clock signal with transition edges of the signal includes causing a clock slip of the sampling clock signal based on a determination that transition edges of the signal are to occur early with respect to the sampling clock signal.

In a second implementation, alone or in combination with the first implementation, adjusting the sampling clock signal to align the sampling clock signal with transition edges of the signal includes causing a clock insert of the sampling clock signal based on a determination that transition edges of the signal are to occur late with respect to the sampling clock signal.

In a third implementation, alone or in combination with one or more of the first and second implementations, adjusting the sampling clock signal to align the sampling clock signal with transition edges of the signal includes adjusting a period of the sampling clock signal based on causing, within a time period, a quantity of clock slips of the sampling clock signal or a quantity of clock inserts of the sampling clock signal that satisfies a threshold.

In a fourth implementation, alone or in combination with one or more of the first through third implementations, determining that the detected transition edges are indicative of the correspondence between the sampling rate and the data rate includes generating data indicating respective quantities of the detected transition edges of the signal that occur at each of a plurality of phase points of the sampling clock signal, and determining that the detected transition edges are indicative of the correspondence between the sampling rate and the data rate of the signal based on the data indicating two distinct peaks.

Although FIG. 4 shows example blocks of process 400, in some implementations, process 400 includes additional blocks, fewer blocks, different blocks, or differently arranged blocks than those depicted in FIG. 4. Additionally, or alternatively, two or more of the blocks of process 400 may be performed in parallel.

The foregoing disclosure provides illustration and description, but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations may not be combined.

As used herein, the term “component” is intended to be broadly construed as hardware, firmware, and/or a combination of hardware and software. It will be apparent that systems and/or methods described herein may be implemented in different forms of hardware, firmware, or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be designed to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A controller for an optical receiver, comprising:
a clock;
one or more processors; and
a memory storing instructions that, when executed by the one or more processors, cause the controller to:
perform, using a sampling clock signal at a sampling rate, oversampling of a signal that is received to detect transition edges of the signal,
wherein the signal is a secondary low-speed signal that is modulated on a primary high-speed signal, and
wherein the sampling rate is in a range of sampling rates over which the sampling clock signal is swept;
determine that the detected transition edges are indicative of a correspondence between the sampling rate and a data rate of the signal; and
adjust the sampling clock signal to align the sampling clock signal with transition edges of the signal.

2. The controller of claim 1, wherein the instructions that cause the controller to adjust the sampling clock signal to align the sampling clock signal with transition edges of the signal, cause the controller to:
cause a clock slip of the sampling clock signal based on a determination that transition edges of the signal are to occur early with respect to the sampling clock signal.

3. The controller of claim 1, wherein the instructions that cause the controller to adjust the sampling clock signal to align the sampling clock signal with transition edges of the signal, cause the controller to:
cause a clock insert of the sampling clock signal based on a determination that transition edges of the signal are to occur late with respect to the sampling clock signal.

4. The controller of claim 1, wherein the instructions that cause the controller to adjust the sampling clock signal to align the sampling clock signal with transition edges of the signal, cause the controller to:
adjust a period of the sampling clock signal based on a determination that a quantity of clock slips of the sampling clock signal or a quantity of clock inserts of the sampling clock signal, caused within a time period, satisfies a threshold.

5. The controller of claim 1, wherein the instructions that cause the controller to determine that the detected transition edges are indicative of the correspondence between the sampling rate and the data rate of the signal, cause the controller to:
generate data indicating respective quantities of the detected transition edges of the signal that occur at each of a plurality of phase points of the sampling clock signal; and
determine that the detected transition edges are indicative of the correspondence between the sampling rate and the data rate of the signal based on the data indicating at least one distinct peak.

6. The controller of claim 5, wherein the at least one distinct peak is two distinct peaks.

7. The controller of claim 1, wherein the signal is encoded by Manchester encoding.

8. The controller of claim 1, wherein a nominal data rate of the signal is 10 kilobits per second, 5 kilobits per second, or 2.5 kilobits per second.

9. An optical receiver, comprising:
a controller with a first clock, the controller configured to:
receive a signal from a remote optical transmitter,
wherein the signal is based on a second clock of the remote optical transmitter, and
wherein the signal is a secondary low-speed signal that is modulated on a primary high-speed signal;
generate a sampling clock signal that is to be swept over a range of sampling rates that are based on the first clock;
perform, using the sampling clock signal at a sampling rate of the range of sampling rates, oversampling of the signal to detect transition edges of the signal;
determine that the detected transition edges are indicative of a correspondence between the sampling rate and a data rate of the signal,
wherein sweeping of the sampling clock signal over the range of sampling rates is to be terminated based on the correspondence between the sampling rate and the data rate; and
adjust the sampling clock signal to align the sampling clock signal with transition edges of the signal by causing a clock slip of the sampling clock signal, by causing a clock insert of the sampling clock signal, or by adjusting a period of the sampling clock signal.

10. The optical receiver of claim 9, wherein the controller, to adjust the sampling clock signal to align the sampling clock signal with transition edges of the signal, is configured to:
cause a clock slip of the sampling clock signal based on a determination that transition edges of the signal are to occur early with respect to the sampling clock signal.

11. The optical receiver of claim 9, wherein the controller, to adjust the sampling clock signal to align the sampling clock signal with transition edges of the signal, is configured to:
cause a clock insert of the sampling clock signal based on a determination that transition edges of the signal are to occur late with respect to the sampling clock signal.

12. The optical receiver of claim 9, wherein the controller, to adjust the sampling clock signal to align the sampling clock signal with transition edges of the signal, is configured to:
adjust a period of the sampling clock signal based on a determination that a quantity of clock slips of the sampling clock signal or a quantity of clock inserts of the sampling clock signal, caused within a time period, satisfies a threshold.

13. The optical receiver of claim 9, wherein the controller, to determine that the detected transition edges are indicative of the correspondence between the sampling rate and the data rate, are configured to:
generate data indicating respective quantities of the detected transition edges of the signal that occur at each of a plurality of phase points of the sampling clock signal; and
determine that the detected transition edges are indicative of the correspondence between the sampling rate and the data rate of the signal based on the data indicating two distinct peaks.

14. The optical receiver of claim 9, wherein the signal is encoded by Manchester encoding.

15. The optical receiver of claim 9, wherein the signal is associated with synchronous communication between the optical receiver and the remote optical transmitter.

16. A method of low-speed synchronous communication, comprising:
receiving, by an optical receiver and from a remote optical transmitter, a signal that is based on a clock of the remote optical transmitter,
wherein the signal is a low-speed signal that is modulated on a primary high-speed signal;
generating, by the optical receiver, a sampling clock signal that is swept over a range of sampling rates;
performing, by the optical receiver and using the sampling clock signal at a sampling rate of the range of sampling rates, oversampling of the signal to detect transition edges of the signal;
determining, by the optical receiver, that the detected transition edges are indicative of a correspondence between the sampling rate and a data rate of the signal;
terminating, by the optical receiver, sweeping of the sampling clock signal over the range of sampling rates based on the correspondence between the sampling rate and the data rate; and
adjusting, by the optical receiver, the sampling clock signal to align the sampling clock signal with transition edges of the signal.

17. The method of claim 16, wherein adjusting the sampling clock signal to align the sampling clock signal with transition edges of the signal comprises:
causing a clock slip of the sampling clock signal based on a determination that transition edges of the signal are to occur early with respect to the sampling clock signal.

18. The method of claim 16, wherein adjusting the sampling clock signal to align the sampling clock signal with transition edges of the signal comprises:
causing a clock insert of the sampling clock signal based on a determination that transition edges of the signal are to occur late with respect to the sampling clock signal.

19. The method of claim 16, wherein adjusting the sampling clock signal to align the sampling clock signal with transition edges of the signal comprises:
adjusting a period of the sampling clock signal based on causing, within a time period, a quantity of clock slips of the sampling clock signal or a quantity of clock inserts of the sampling clock signal that satisfies a threshold.

20. The method of claim 16, wherein determining that the detected transition edges are indicative of the correspondence between the sampling rate and the data rate comprises:
generating data indicating respective quantities of the detected transition edges of the signal that occur at each of a plurality of phase points of the sampling clock signal; and
determining that the detected transition edges are indicative of the correspondence between the sampling rate and the data rate of the signal based on the data indicating two distinct peaks.
